(19) United States
(12) Patent Application Publication
(10) Pub. No.: US 2002/0066507 A1
(43) Pub. Date: Jun. 6, 2002

(54) Vehicle tire equipped with temperature indicator

(76) Inventors: Mika Sievi-Korte, Viiala (FI); Samuli Loytonen, Tampere (FI); Juha Laitsaari, Tampere (FI)

Correspondence Address: KLARQUIST SPARKMAN, LLP, One World Trade Center, Suite 1600, Portland, OR, 97204, US

(21) Appl. No.: 09/944,931

(22) Filed: Aug. 31, 2001

(30) Foreign Application Priority Data
Sep. 1, 2000 (FI) FI 20001929

(51) Int. Cl. B60C 11/00

(52) U.S. Cl. 152/209.16; 152/525

(57) ABSTRACT

The invention relates to a vehicle tire comprising a tread in road contact, which comprises a surface that gets in road contact during free rotation of the tire and two shoulder areas on each side of the central plane, and located in order, on each side of the tread and symmetrically to the central plane, two tread wing areas extending the shoulder areas and two sidewalls. The tire of the invention is characterized by at least part of the tire being made of a material that varies in color with the temperature.

### RELATED APPLICATION DATA

This application claims priority to Finnish patent application number 20001929, filed Sep. 1, 2000.

### FIELD OF THE INVENTION

The invention relates to a vehicle tire having a tread in road contact, which comprises a surface in road contact during free rotation of the tire and two shoulder areas on each side of the central plane, and, located in order on each side of the tread and symmetrically to the central plane, two tread wing areas extending the shoulder areas and two side walls.

### BACKGROUND

Several solutions have been proposed for the measurement of the tire temperature in the field of tire technology. All these solutions have the common feature of comprising some kind of sensor, transmitter and receiver. The arrangement disclosed in U.S. Pat. No. 5,483,827 can be cited as an example, in which the tire is provided with an intelligent chip including among other things a temperature detector, a power source, a transmitter and an aerial.

However, solutions of the kind mentioned above also involve the drawback of difficult retrofitting in cars after manufacture. They are also expensive and have a complex structure. In addition, they comprise several components that risk getting out of order. Thus their maintenance is also expensive.

Consequently, the purpose of the invention is to provide a vehicle tire that indicates the tire and/or outdoor temperature in a simple and economical manner. Another purpose of the invention is to provide such a tire that can be fitted also in secondhand cars.

The purposes of the invention have been achieved with the solution described in the accompanying claims.

### SUMMARY

The invention relates to a vehicle tire, which is characterized by at least part of the tire being made of a material that varies in color with temperature.

Thus, the vehicle tire of the invention immediately indicates the outdoor and/or tire temperature. The temperature at which said material varies in color can be selected for the purpose of use in each case. The color may change for instance when the temperature drops below 0° C., or when the temperature rises to a temperature at which the tire can no longer be safely used. The temperature range −40° C. to +125° C. can be mentioned as an example. The temperature range may evidently be wider or narrower, for instance between +5° C. and −5° C. The color usually changes in a given temperature range, but not at a given temperature. The color may naturally also vary from colorless to colored or from one color to another, etc.

Hence, the outdoor and/or tire temperature is easy and simple to observe by means of the vehicle tire of the invention. Thus a summer tire equipped with a temperature indicator allows the risk of an iced road surface to be predicted. The invention is also economical, and it does not impose any special requirements regarding the properties of the vehicle, the tires of the invention being applicable to any vehicles.

In one embodiment of the invention, the material that varies in color with the temperature may be at least one part of at least one sidewall of the tire, at least one part of one tread wing area of the tire, or of both of these. It is obvious to those skilled in the art that the position of this material can be freely selected. It is also obvious to those skilled in the art and to the user of the vehicle that the solution of the invention indicates the temperature of a tire than has been recently running, since the tire is heated while it is running.

Said material that varies in color with the temperature can obviously be located in the tire in any shape desired. The material may for instance occur as a suitable pattern on the tire surface, such as the manufacturer's logo, as letters or figures indicating the temperature, or in the form of stripes. It is further possible to show various technical data (speed rating, size, construction, etc.) by means of such a material. The material may also be provided as a separate part, such as a button, which is embedded in the tire in any manner known per se to those skilled in the art, e.g. by shape locking. In addition, one part of the tire may be made of a suitable rubber material, to which such material that varies in color has been added.

In a preferred embodiment of the invention, said material that varies in color with the temperature is a thermo-chrome pigment. The thermo-chrome pigment has preferably been mixed with plastic. The plastic may be for instance amorphous plastic, allowing a particularly effective color effect to be achieved. We cite as examples of potential plastic materials polyethylene, polypropylene, polystirene, polyacrylonitrile butadiene sytrene (ABS), or blends of these. Such mixed plastic can generally be processed using normal plastic processing methods, such as injection moulding, blow moulding and extrusion.

The material varying in color is used for instance in a ratio of about 5-75% by weight, the preferred ratio depending on the material used. Regarding thermo-chrome pigments, the preferred ratio is about 5-25% by weight of the total amount of material. The required amount is also affected by the wall thickness used: usually, the thicker the wall, the smaller the amount of pigment required relative to the overall weight.

### BRIEF DESCRIPTION OF THE DRAWINGS

The invention is described in further detail with reference to the accompanying drawings, in which

FIG. 1 shows the general design of the tire of the invention,

FIG. 2 is a side view of a first embodiment of the invention,

FIG. 3 is a side view of a second embodiment of the invention, and

FIG. 4 is a side view of a third embodiment of the invention.

### DETAILED DESCRIPTION

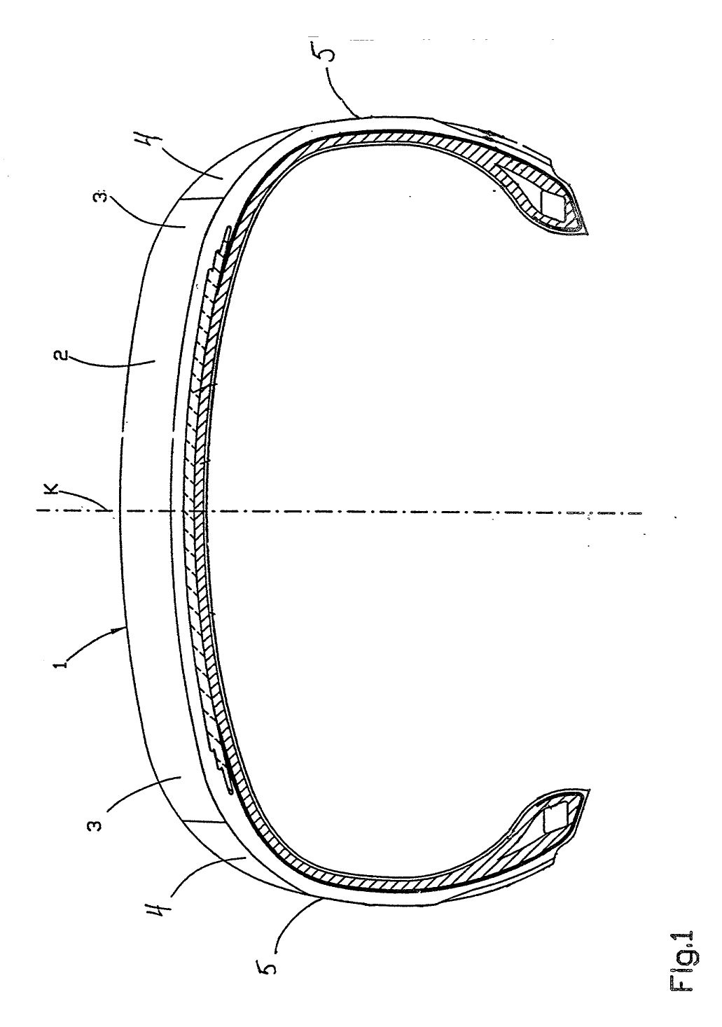

FIG. 1 shows the general structure of the tire of the invention. The figure shows the tread 1 that gets into road contact, the tread comprising a surface 2 that gets into road contact during free rotation of the tire, and two shoulder areas 3 on each side of the central plane K. The figure also shows, in order on both sides of the tread 1 and symmetrically to the central plane K, two tread 1 wing areas 4 extending the shoulder areas 3 and two side walls 5.

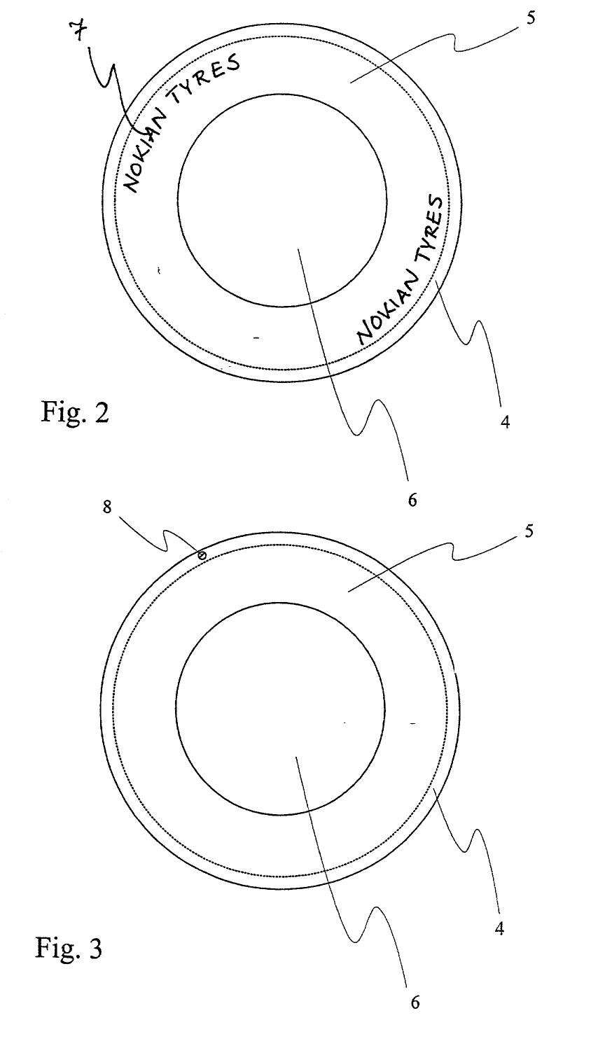

FIG. 2 shows a first embodiment of the invention. The figure shows the vehicle tire of the invention as a side view. The figure shows the tread wing area 4 and the sidewall 5 of the tire, which have been distinguished with an imaginary broken line. The figure also shows the tire rim 6. The figure further shows the pattern 7 of a first embodiment of the invention, which is a letter pattern 7 made of a material varying in color on the sidewall 5 of the tire.

FIG. 3 shows a second embodiment of the invention, which is a button 8 made of a material varying in color in the tread wing area 4 of the tire and fastened in any manner known by those skilled in the art, for instance by shape locking. Of course, this can also be a color spot on the tire surface. The button or spot can also naturally have any shape.

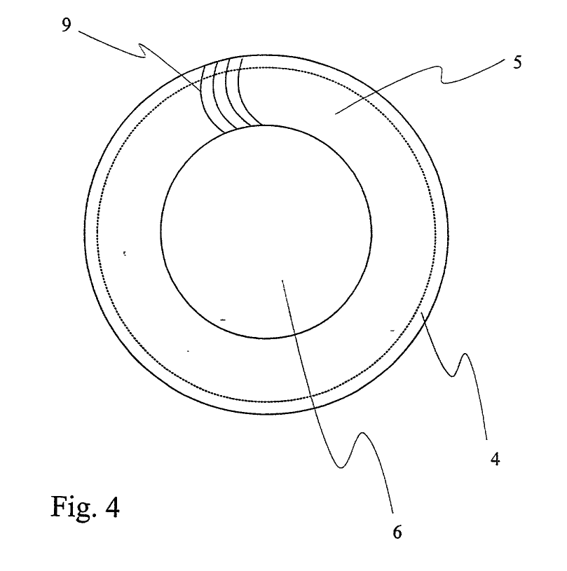

FIG. 4, in turn, shows a third embodiment of the invention, which is a pattern 9 made of a material that varies in color and extends from the tread wing area 4 of the tire to the sidewall 5 of the tire.

We claim:

1. A vehicle tire comprising a tread in road contact, which comprises a surface that gets into road contact during free rotation of the tire, and two shoulder areas on each side of the central plane (K), and, located in order on each side of the tread and symmetrically to the central plane (K), two tread wing areas extending the shoulder areas and two sidewalls, comprising material, on at least part of the tire, that varies in color with temperature.

2. A tire as defined in claim 1, wherein said material varies in color with the temperature in the temperature range −40° C.-+125° C.

3. A tire as defined in claim 1, wherein at least part of at least one sidewall of the tire is made of said material that varies in color with the temperature.

4. A tire as defined in claim 1, wherein at least part of at least one tread wing area is made of said material that varies in color with the temperature.

5. A tire as defined in claim 3, wherein at least part of at least one sidewall of the tire and at least part of at least one tread wing area is made of said material that varies in color with the temperature.

6. A tire as defined in claim 1, wherein said material that varies in color with the temperature is a thermo-chrome pigment.

7. A tire as defined in claim 6, wherein said thermo-chrome pigment is mixed in a plastic material.

8. A tire as defined in claim 7, wherein said plastic material is an amorphous plastic.

9. A tire as defined in claim 7, wherein said plastic material is selected in the group consisting of polyethylene, polypropylene, polystirene, polyacrylonitrile butadiene sytrene, and mixtures of these.

10. A vehicle tire comprising:
a tread, opposing wing areas adjacent the tread and opposing shoulder areas adjacent the wing areas; and
material that varies in color with temperature positioned on at least one of the wing areas, at least one of the shoulder areas, or on both the wing and shoulder areas.

11. The vehicle tire as defined in claim 10, wherein the material varies in color with the temperature in the temperature range −40° C.-+125° C.

12. The vehicle tire as defined in claim 10, wherein said material that varies in color with the temperature is a thermo-chrome pigment.

13. The vehicle tire of claim 12, wherein said thermo-chrome pigment is mixed in a plastic material.

14. The vehicle tire of claim 13, wherein said plastic material is an amorphous plastic.

15. The vehicle tire of claim 13, wherein said plastic material is selected from a group consisting of polyethylene, polypropylene, polystirene, polyacrylonitrile butadiene sytrene, and combinations thereof.
